(19) United States
(12) Patent Application Publication
(10) Pub. No.: US 2013/0208418 A1
(43) Pub. Date: Aug. 15, 2013

(54) AFFIXABLE, DETACHABLE PLATFORM SET FOR PORTABLE COMPUTERS

(71) Applicant: Michael Victor Lucido, San Bernardino, CA (US)

(72) Inventor: Michael Victor Lucido, San Bernardino, CA (US)

(21) Appl. No.: 13/397,672

(22) Filed: Feb. 15, 2012

(51) Int. Cl. G06F 1/20; G06F 1/16

(52) U.S. Cl. CPC G06F 1/203; G06F 1/1633
USPC 361/679.46; 361/679.55

(57) ABSTRACT

Users of portable computers tend to carelessly place their usage of such where damage to their units become inevitable, unintentionally setting them in places which blocks air from circulating through such systems.

For most laptops/notebook computers, a circulating blower sucks air from underneath the unit through an intake vent, and blows it past the Central Processing Unit (CPU) before exiting the system, at the side. The present invention is a supporting platform which is affixable to the bottom of any laptop computer. This platform allows the user to place the laptop on virtually any surface, without having to detach it upon disuse transport, and/or storage. It is a continuity clearance utility providing maximum air flow for which the unit was originally designed. This platform is affixable, detachable and fits comfortably with the laptop inside its carrying case.

### FIELD OF THE INVENTION

This invention relates generally to a laptop computer's ability to maintain its cooling capacity whenever and wherever it might be used in a position when its air intake vent (located at the bottom of the unit) may become blocked. It relates more specifically to providing an adequate clearance for air flow between the platform which guards against the users careless placement onto surfaces which may block the computer's air intake vent.

This invention relates to a platform structure which is made of rigid material which is lightweight, and by nature of the sub-strait insulates from many objectionable conditions.

This invention relates to an area of diversities with which a laptop computer may be operated comfortably and efficiently. The comfort-ability aspect is directly related to where the system is set in place, how it is handled, and how long it may be run within such place. The efficiency aspect is dependent on several other factors, one of which is the maintenance of the system in general. Life expectancy is directly related to how well the central processing unit stays cool.

The present invention is a platform made to be semi-permanently affixed to the laptop for the life span of the computer and has the capacity to infallibly last, much longer than the computer, to be used on future replacement computers.

The base is to be at least ½″ larger than the computer on all four sides to prevent air flow blockage when sitting on soft material such as a pillow.

The platform is attached to the bottom of the computer by way of a flexible semi-permanent fastening system, which provides a raised cushioning layer which elevates the bottom of the laptop computer to provide adequate air flow for cooling.

The basic characteristics, design and material used for this present invention, as here-in specified; together with the fastening system which supports the platform and secures it to the bottom of the laptop, is a unique utility.

### PRIOR ART

All of the similar types of platforms within the prior state of the art are based on models which attempt to advance further cooling of the computer system using rotary fans, and other electricity based operations, as well as those which need to be refrigerated prior to use, if not only to sit atop of a structure which is neither ergonomic nor stable. The prior state of the art has led to a bulky, wired, carry-along, or some spongy thick protruding styles of platforms which the computer may precariously sit upon and must be assembled and or disassembled with every use. More so, it appears that the prior state of the art will lead to some form of breakdown, cracking or malfunction over a short period of use.

Virtually all previous cooling systems require electricity drawn from the computers battery thereby reducing the charge life of the battery by up to fifty percent.

Virtually all the prior art designs do not provide attachment to the computer, thereby making a very difficult balancing act if placed on soft surfaces such as, pillows, bedding, laps, clothing, etc. All other platforms are not only cumbersome, bulky and awkward to use, they tend to be flimsy, and more dangerous to the computer than they are worth.

### SUMMARY OF THE INVENTION

The present invention comprises a platform made from a ridged or semi-rigid flat relatively thin material such as Melamine, Masonite, Aluminum, Plastic, or any composite type material which is resistant to cracking due to cold temperatures, UV exposure, or impact.

The platform is attached to the computer with semi-permanent resilient attachments such as adhesive backed hook and loop Velcro or Jelly Polyurethane or Jelly Silicone coins in any two dimensional geometry with adequate thickness to allow proper air flow for cooling and adequate adhesion between the computer and the base to maintain a structural connection for use or handling without unwanted detachment and yet allow easy detachment when required for things such as repair to the computer.

In the case of the use of adhesive backed Velcro, two layers of hook and two layers of loop are sandwiched together. The airflow gap can be increased by the addition of a rigid spacer installed between the adhesive backings of the center two layers of Velcro.

The low profile characteristics allow the full assembly to be placed in a carrying case, or other type of computer bag, without disassembly.

The object of this design is to provide an improved approach to the number one issue of airflow clearance.

### BACKGROUND OF THE PRESENT INVENTION

This invention began as a way to protect the inventor's laptop/notebook computer from overheating when simply placing it on his lap. In 2004 a Plexiglas base was created, which was fastened to the bottom of the laptop with formfitting wall-anchors which were fastened to the base with screws through the base.

This was not conducive to efficiently duplicate due to the variability of screw hole placements from one computer to another. After six months time, the Plexiglas cracked in many places. The result was that a new surface was chosen but the same screw type, wall-anchors were used to secure the platform to the computer. Sometimes, this would fall off during transport, and would bend screws holding the anchors, sometimes breaking off and would scratch the laptop's bottom. Still, this was not good for duplication. In November 2010 another board was made without the screws. The attachment mechanism became a modified adhesive backed hook and loop tape (such as hook and loop Velcro) fastening system which allowed an adequate space between the computer and platform allowing maximum ventilation clearance. It was then realized that this was duplicatable and that it could fill an enormous need.

### BRIEF DESCRIPTION OF THE DRAWINGS

The accomplishments of the above mentioned object of the present invention will become apparent from the following description and its accompanying drawings, which disclose illustrative embodiments of the present invention and are of the following figures, 1 through 5:

FIG. 1. This is a drawing of the side view where the laptop/notebook screen (1) is closed and the platform (5) is fastened to the bottom of the computer. (2) The intake vent (3) is displayed at the bottom of the computer. (4) The exit air vent is displayed. The laptop/notebook computer's foot (7) two modified loop and hook-tape fasteners (6) are also displayed.

FIG. 2. This drawing displays the front of the laptop/notebook computer with a closed screen. (5) Shows the platform, (8) extending out 1 inch from under the right side (6) of the computer, with modified loop and hook type fasteners. (7) Displays the computer's rubber footing, as well as the front two modified (6) loop and hook-tape fasteners. (3) Shows where the intake vent is displayed.

FIG. 3. This drawing is a detailed view of a modified loop and hook type fastener. It elaborates on exactly how it is used within this application. There is placement of hook tape, (9) specific to this application adhered with an adhesive coating to the bottom of the laptop computer near the area where the computer's footings reside. (7) Since the footings of the computer are usually farthest from the center, the hook placement is usually near the inside of each footing area, (7) The loop part of the loop and hook tape is constructed by adhering the adhesive side of two Velcro loop tapes back to back. The bottom part of the fastener is attached to the upper face of the platform and is adhered with the same type of adhesive coating. It is understood that the arrangement of hook to loop and loop to hook can be reversed if desired.

FIG. 4. This drawing illustrates an exploded view of the laptop when it is secured properly to the platform the drawing shows both the upper face of the platform and the upper face of the laptop computer (2) with the screen (1) open. The dotted line (8) to the right of the platform is only a suggestive guide. Some user's may want the extension on the other side or a little on both sides. The exit air vent is displayed (4). (6) The bottom hook-tape with the modified loop-pile placement is shown to be generally inside the corners near the computer footings.

FIG. 5. This drawing illustrates the underside of the computer (2). It illustrates the placement of the pluralities of semi-permanent fasteners (6) near the laptop computer's footings (7). It also illustrates where one possible arrangement might be for the air-intake vent (3) and the air-exit-vent (4) for one type of laptop computer. The semi-permanent flexible fasteners should never cover the intake vent (3) nor interfere with the footing (7).

FIG. 6. This is a detail drawing of a Jelly Polyurethane or Jelly silicone coin (11) fastener option to replace the hook and loop fastener option (6, 9,10). The semi-permanent natural sticky surface characteristics replace the need for adhesive backed Velcro hook and loop assemblies.

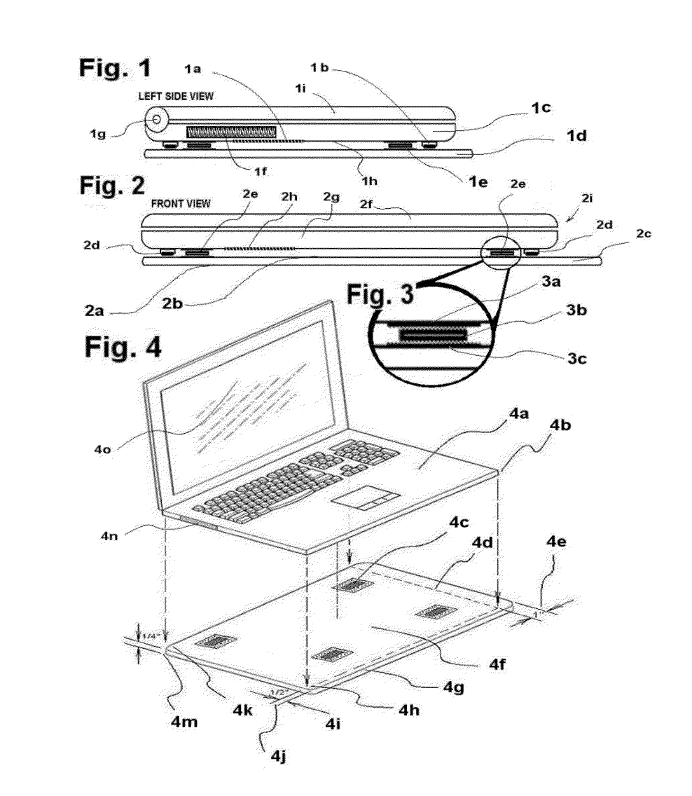

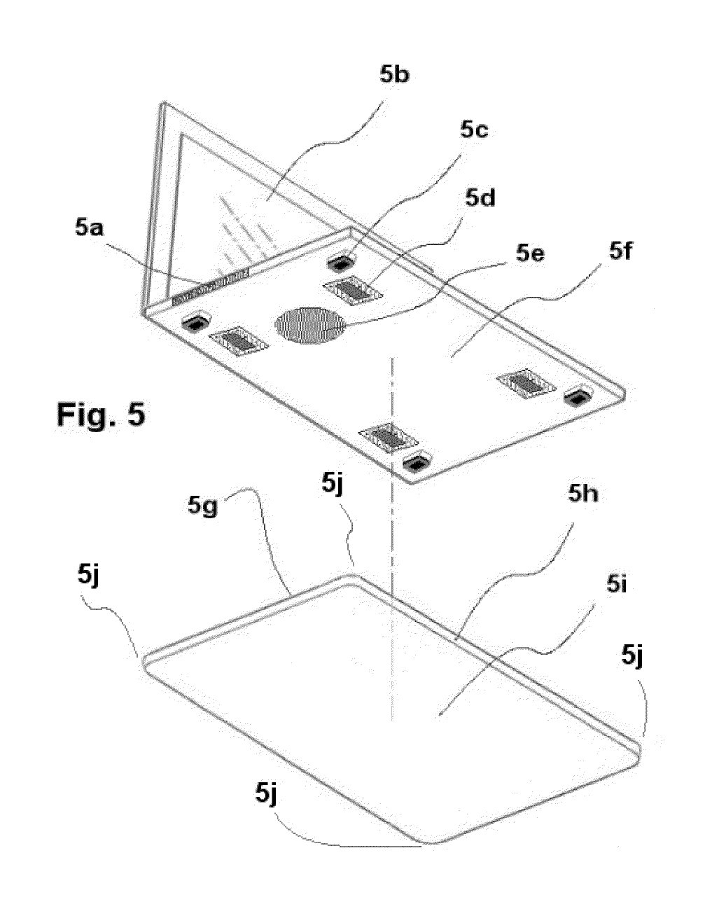

### PROCESS OF PRODUCTION AND IMPLEMENTATION

The Platform as described in paragraph [0012] can be produced using any number of methods including being sheared or injection molded from many different kinds of plastics, or can be saw or router cut from materials such as Melamine, Masonite, or Aluminum.

### DESCRIPTION OF THE PREFERRED EMBODIMENT

While a preferred embodiment of the invention has been shown and described in detail, it will be readily understood and appreciated that, changes and additions may be made throughout the course of development and improvement of this product without departing from the spirit and scope of the invention.

1. A platform made of a rigid substrate with smooth surfaces on two main flat sides and cut according to appropriate measurements of the utility it serves, and fastened to the object of its utility in a way not devised by any other, before this application, and has not been published in any form prior to the disclosure of Provisional Patent Application to USPTO, Feb. 18, 2011. *

2. The present invention has a unique approach in the way that it provides an attractive and ergonomic utility for protecting a laptop computer's airflow over which a platform fits so snugly that the user soon forgets it is part of the system, having no rubber footings, and no other objective apparatus to hinder any part of its appeal, is by and large and without question beneficially useful and unique within its application.

3. Utilizing a modification of hook and loop tape fasteners, which is a unique product of this utility, the platform becomes affixable to the unit, as such does so in that it become part of the inheritable system, not to be removed for any reason other than repair or maintenance, the same as would be for the housing of the components which provide the operating system of the data processing appliance, itself.

4. Such as the processing unit which the platform supports has default parameters, so does the utility of the affixable platform has default measurements and has a smooth bottom which provides within its default configuration, no rubber stationary supports. This default uniformity provides unique characteristics to the handling of the system, both for transport and usage, uniquely beneficial, and different than any other system devised.

5. The fastening system this platform uses is another modification unique within this utility. The hook tape and fibrous loop assembly applies to the specific affix-ability type, which is implicated with the bond set forth for the utility of its purpose. The fibrous loop, centerpiece is assembled with additional components which support defined parameters (0007, 0037) which implement supplemental characteristics. (0036)

6. The center composition, hidden within the assembly of the double faced fibrous loop construct, consists of various materials, which will be one or another, while the content may vary with future improvements, where-as the assembly structure remains consistent.

7. Hidden within, inside each center mesh of double-sided fibrous loop constructs, as is part of the unique fastener type which secures the bond for which the utility comprises, lies a supportive material, comprising of wood, plastic, or rubber, as is the variable, and as such meets various specifications.

8. The utility specifications regarding loop and hook may be reversed and would maintain the corresponding utility, here-in, which are specified within this application, while in this application and documentation is here-for-to specified as loop on the inside, as it is the center part, while the hook is a plurality which is part of a substrate which adheres to the common objects of the utility by way of an adhesive component charged by way of exposure after discarding of a peel-off-component.

9. This invention is essentially a barrier against harmful substances which cause over-heating of portable computers by way of air blockage from careless placement over flexible surfaces.

10. Notes: The wording of item #1. has been changed, originating from the Provisional Patent Application of Feb. 18, 2012, which was of the following:
A platform made of compressed fibrous naturally occurring materials coated with a melamine surface on two main flat sides and cut according to appropriate measurements of the utility it serves, and fastened to the object of its utility in a way not devised by any other, before this application, and has not been published in any form until this disclosure.
